(19) United States
(12) Patent Application Publication
(10) Pub. No.: US 2026/0009963 A1
(43) Pub. Date: Jan. 8, 2026

(54) MAGNETIC PRIVACY SCREEN FILTER

(71) Applicant: EYEGUARD CO., LTD., Seoul (KR)

(72) Inventor: Yang-Jin MOON, Gwacheon-si (KR)

(21) Appl. No.: 19/126,365

(22) PCT Filed: Sep. 26, 2023
(86) PCT No.: PCT/KR2023/014755

§ 371 Date: May 1, 2025

(30) Foreign Application Priority Data
Nov. 2, 2022 (KR) 1020220144194

(51) Int. Cl. G02B 7/00; B32B 3/26; B32B 7/025; B32B 7/12; B32B 27/36; G02B 5/20

(52) U.S. Cl. CPC G02B 7/006; B32B 3/266; B32B 7/025; B32B 7/12; B32B 27/36; G02B 5/20; B32B 2307/40; B32B 2457/20; G02B 2207/123

(57) ABSTRACT

The present disclosure relates to a magnetic privacy screen filter, and in particular, to a magnetic privacy screen filter capable of blocking information displayed on a screen according to a viewing angle. To this end, an aspect of the present disclosure may include a filter for blocking information displayed on a screen selectively according to a viewing angle, a magnetic sheet arranged on one surface of the filter, and an adhesive tape arranged on another surface of the filter.

### TECHNICAL FIELD

The present disclosure relates to a magnetic privacy screen filter, and in particular, to a magnetic privacy screen filter capable of blocking information displayed on a screen according to a viewing angle.

### BACKGROUND ART

Recently, according to developments in technology, electronic display devices such as smartphones, tablet personal computers (PCs), laptop computers, etc. are essential for people, and are used variously in daily life.

For example, electronic display devices are widely used in various fields such as work, shopping, hobby, finance, study, etc. by modern people, and the scope of use is expected to widen further in the future.

As described above, electronic display devices provide users with various advantages, but as the scope of use increases, there is a risk that personal information or privacy of a user may be exposed to outside.

In particular, users generally use electronic display devices regardless of time and place, and in some cases, content displayed on a screen of an electronic display device may be exposed to people around the user. [symbol] In this case, people in the periphery may acquire user's personal information or may violate the privacy of the user, from the information displayed on the screen of the electronic display device of the user.

Accordingly, there is a demand for developing a unit capable of protecting the user's personal information and privacy by allowing the information on the screen to be displayed only to the user and not to be displayed to the other people, and being easily attached to/detached from the screen of the electronic display device.

### DISCLOSURE OF INVENTION

### Technical Problem

The present disclosure provides a magnetic privacy screen filter capable of blocking information displayed on a screen according to a viewing angle.

Also, the present disclosure provides a magnetic privacy screen filter that may be easily attached to/detached from a screen.

However, the above technical features are exemplary, and the scope of the disclosure is not limited thereto.

### Solution to Problem

To achieve the above purpose, an aspect of the present disclosure may include a filter for blocking information displayed on a screen selectively according to a viewing angle, a magnetic sheet arranged on one surface of the filter, and an adhesive tape arranged on the other surface of the filter.

Also, the magnetic sheet may be formed to extend along at least a part of the boundary of the filter to have a length.

Also, the filter may include a first opening formed concave toward the inside, and the magnetic sheet may include a second opening in a location corresponding to the first opening formed in the filter.

Also, the adhesive tape may be formed to extend along at least a part of the boundary of the filter to have a length.

### Advantageous Effects of Invention

The present disclosure may provide a magnetic privacy screen filter capable of blocking information displayed on a screen according to a viewing angle.

Also, the present disclosure may provide a magnetic privacy screen filter that may be easily attached to/detached from a screen.

However, the above effects are examples, and the scope of the disclosure is not limited thereto.

### BRIEF DESCRIPTION OF DRAWINGS

FIGS. 1 and 2 are diagrams schematically showing a usage example in which a magnetic privacy screen filter according to the present disclosure is attached to a screen of an electronic display device to be used.

FIG. 3 is a perspective view schematically showing a magnetic privacy screen filter according to an embodiment of the present disclosure.

FIG. 4 is an exploded perspective view of the magnetic privacy screen filter of FIG. 3.

FIG. 5 is a diagram schematically showing the magnetic privacy screen filter of FIG. 3, which is seen from the front.

FIG. 6 is a diagram schematically showing the magnetic privacy screen filter of FIG. 3, which is seen from the side.

FIG. 7 is a diagram for describing a structure of the filter of FIG. 3, according to an embodiment.

FIG. 8 is a diagram for describing a structure of the filter of FIG. 3, according to another embodiment.

FIG. 9 is a diagram for describing a structure of an adhesive tape of FIG. 4.

FIG. 10 is a perspective view schematically showing a magnetic privacy screen filter according to another embodiment of the present disclosure.

FIG. 11 is an exploded perspective view of the magnetic privacy screen filter of FIG. 10.

FIG. 12 is a diagram schematically showing the magnetic privacy screen filter of FIG. 10, which is seen from the front.

FIG. 13 is a diagram schematically showing the magnetic privacy screen filter of FIG. 10, which is seen from the side.

### BEST MODE FOR CARRYING OUT THE INVENTION

To achieve the above purpose, an aspect of the present disclosure may include a filter for blocking information displayed on a screen selectively according to a viewing angle, a magnetic sheet arranged on one surface of the filter, and an adhesive tape arranged on the other surface of the filter.

### MODE FOR THE INVENTION

As the present disclosure allows for various changes and numerous embodiments, particular embodiments will be illustrated in the drawings and described in detail in the written description. [symbol] The attached drawings for illustrating one or more embodiments are referred to in order to gain a sufficient understanding, the merits thereof, and the objectives accomplished by the implementation. [symbol] However, the embodiments may have different forms and should not be construed as being limited to the descriptions set forth herein.

[symbol]

The embodiments will be described below in more detail with reference to the accompanying drawings. Those components that are the same or are in correspondence are rendered the same reference numeral regardless of the figure number, and redundant explanations are omitted.

[symbol]

While such terms as “first,” “second,” etc., may be used to describe various components, such components are not be limited to the above terms. The above terms are used only to distinguish one component from another.

[symbol]

An expression used in the singular encompasses the expression of the plural, unless it has a clearly different meaning in the context.

In the present specification, it is to be understood that the terms “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

[symbol]

Sizes of components in the drawings may be exaggerated for convenience of explanation. In other words, since sizes and thicknesses of components in the drawings are arbitrarily illustrated for convenience of explanation, the following embodiments are not limited thereto.

The x-axis, the y-axis and the z-axis are not limited to three axes of the rectangular coordinate system, and may be interpreted in a broader sense. [symbol] For example, the x-axis, the y-axis, and the z-axis may be perpendicular to one another, or may represent different directions that are not perpendicular to one another.

[symbol]

When a certain embodiment is implemented differently, a specific process order may be performed differently from the described order. For example, two consecutively described processes may be performed substantially at the same time or performed in an order opposite to the described order.

Hereinafter, a magnetic privacy screen filter according to the present disclosure is described with reference to accompanying drawings in detail, based on the above-mentioned rules.

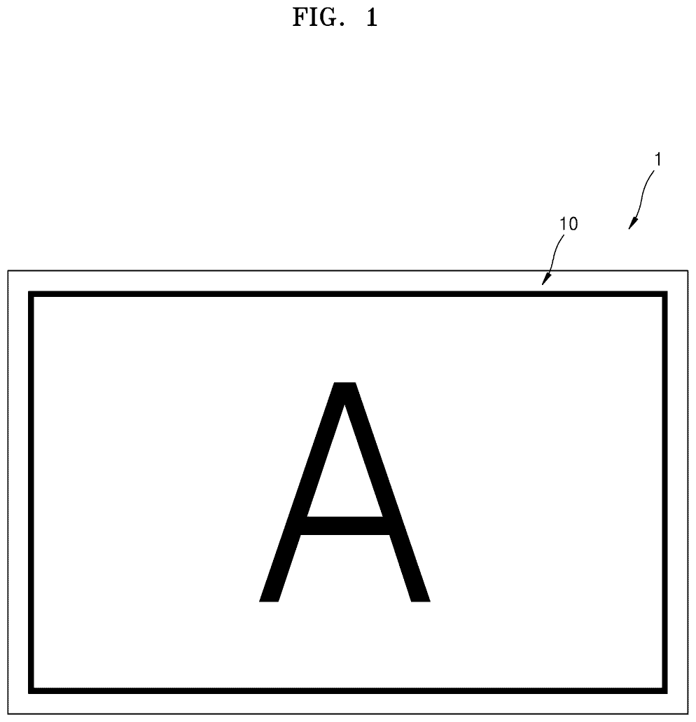

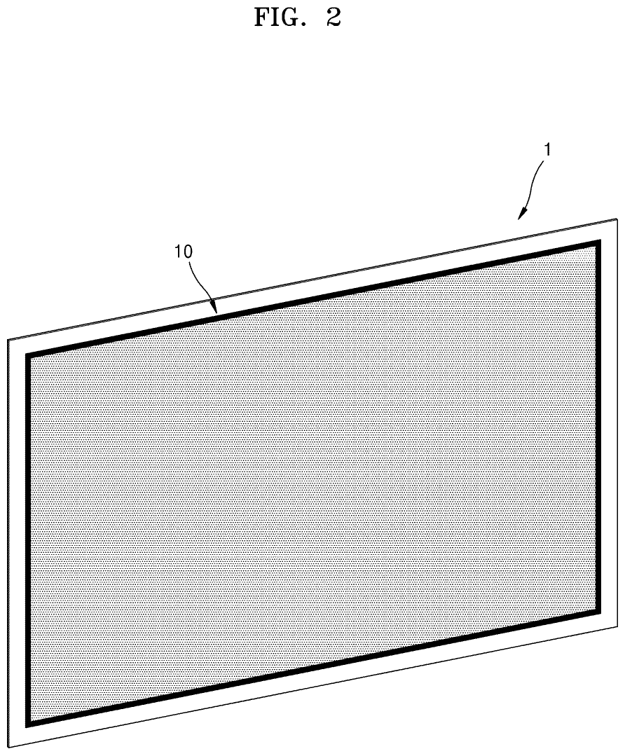

FIGS. 1 and 2 are diagrams schematically showing a usage example in which a magnetic privacy screen filter 10 according to the present disclosure is attached to a screen 1 of an electronic display device.

Referring to FIGS. 1 and 2, the magnetic privacy screen filter 10 according to the present disclosure may be used while being attached to the screen 1 of the electronic display device.

The electronic display device may denote an electronic device displaying information through the screen 1, for example, a smartphone, a notebook computer, a laptop computer, a tablet personal computer (PC), etc.

The magnetic privacy screen filter 10 may be attached to one surface of the screen 1 of the electronic display device, and may selectively block information displayed on the screen 1.

For example, the magnetic privacy screen filter 10 may not block the information displayed on the screen 1, as shown in FIG. 1, when a user watches the screen 1 from a viewing angle within a certain range. [symbol] Preferably, when the user watches the screen 1 straight from the front, the magnetic privacy screen filter 10 may clearly show the information displayed on the screen 1 without blocking the information.

On the contrary, as shown in FIG. 2, the magnetic privacy screen filter 10 may block the information displayed on the screen 1, when the user watches the screen 1 from a viewing angle out of the certain range. [symbol] For example, when the user watches the screen 1 slantly from sides, the magnetic privacy screen filter 10 may block the information displayed on the screen 1 so as to make the content displayed on the screen 1 invisible. [symbol] Specifically, when the user watches the screen 1 slantly from the sides, the magnetic privacy screen filter 10 may allow only a certain color such as black, etc. to be represented on the surface of the magnetic privacy screen filter 10.

The magnetic privacy screen filter 10 may be attachable to/detachable from the screen 1. Therefore, when the magnetic privacy screen filter 10 is damaged or durability degrades, the user may easily replace the magnetic privacy screen filter 10.

In an embodiment, the magnetic privacy screen filter 10 according to the present disclosure may be attached to the screen 1 via magnetism.

For example, the magnetic privacy screen filter 10 includes a magnetic material that may be attached to a magnet built in the electronic display device, so as to be attached to the screen 1 of the electronic display device.

Therefore, issues such as leaving a trace of adhesive when the adhesive is used or damage to the electronic display device due to the mechanical coupling may be prevented.

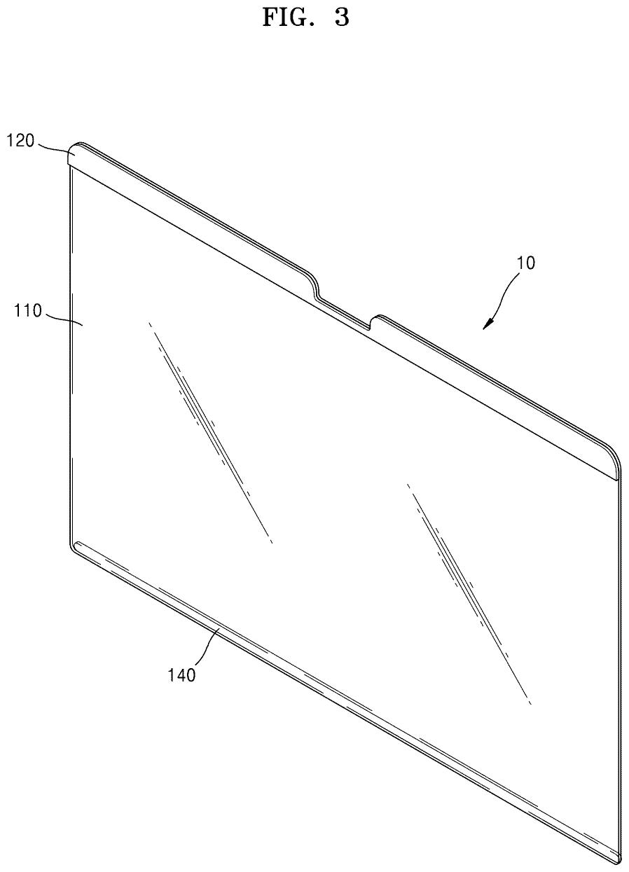

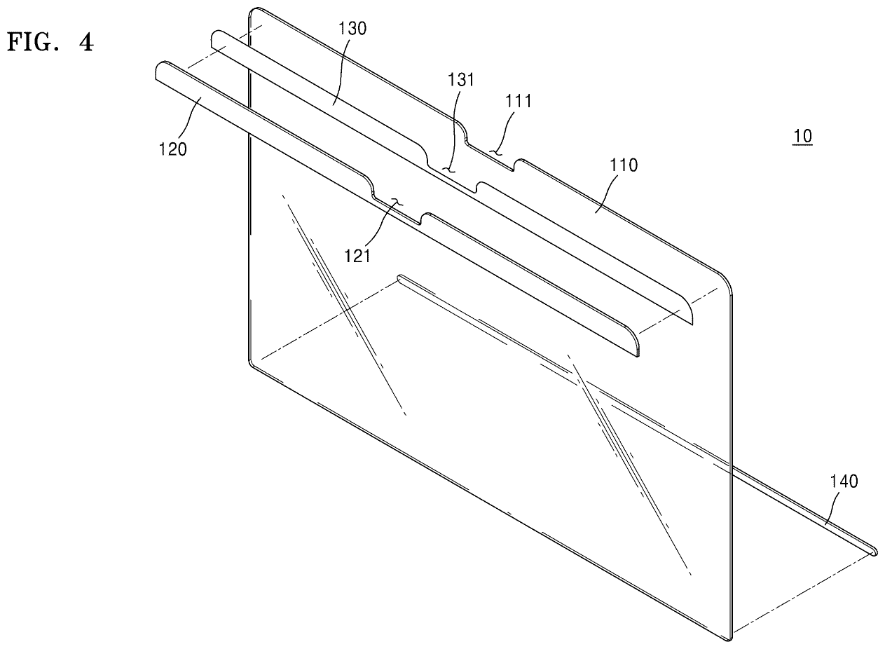

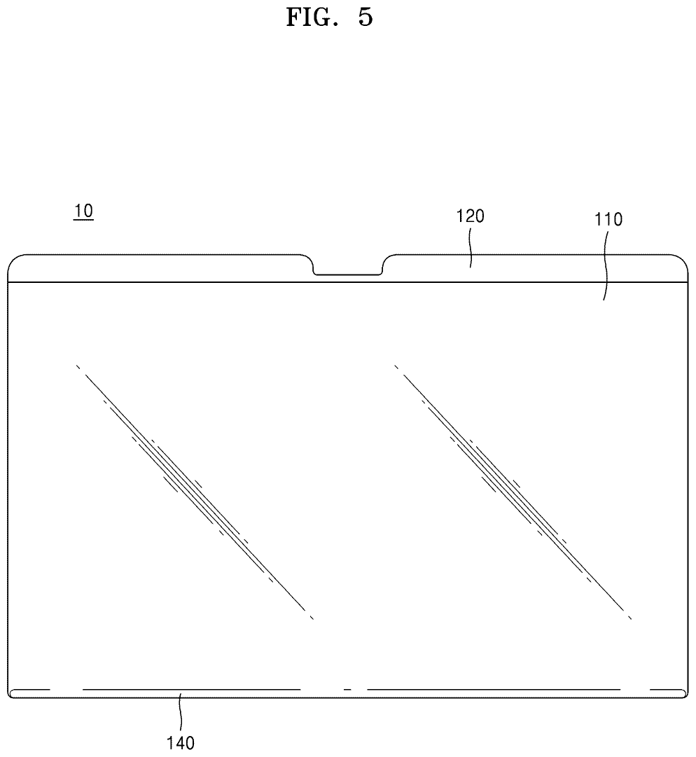

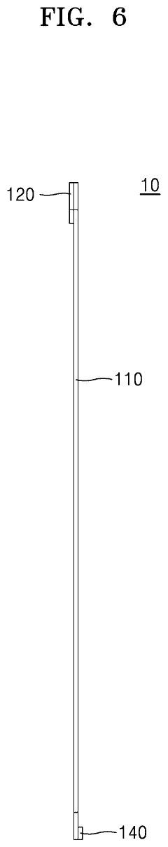

FIG. 3 is a perspective view schematically showing the magnetic privacy screen filter 10 according to an embodiment of the present disclosure, and FIG. 4 is an exploded perspective view of the magnetic privacy screen filter 10 of FIG. 3. FIG. 5 is a diagram schematically showing the magnetic privacy screen filter 10 of FIG. 3, which is seen from the front, and FIG. 6 is a diagram schematically showing the magnetic privacy screen filter 10 of FIG. 3, which is seen from the side.

Referring to FIGS. 3 to 6, the magnetic privacy screen filter 10 according to an embodiment of the present disclosure may include a filter 110, a magnetic sheet 120, and an adhesive tape 140.

The filter 110 may be arranged on one surface of the electronic display device. For example, the filter 110 may be arranged to be adjacent to the screen 1 of the electronic display device and cover the screen 1.

The filter 110 may block the information displayed on the screen 1 selectively according to a viewing angle. That is, the information displayed on the screen 1 may be displayed to outside via the filter 110. Here, the information displayed to outside via the filter 110 may be clearly displayed only when seen from a certain viewing angle, and may not be displayed when seen from a viewing angle out of a certain range.

The filter 110 may be formed as a plate to have an area. Here, the filter 110 may have an area that is enough to cover the entire screen 1.

In an embodiment, the filter 110 may include a first opening 111.

The electronic display device may frequently have various devices such as a camera, a sensor, etc. in an upper portion of the screen 1. Therefore, when the magnetic privacy screen filter 10 is arranged to cover the boundary of the screen 1, there is a concern that the magnetic privacy screen filter may block the device such as a camera, etc. to hinder the functions.

Therefore, the filter 110 may include the first opening 111 formed at a position corresponding to the camera, etc. so as not to block the device such as the camera, etc.

In an alternative embodiment, the first opening 111 may be formed concave toward the inside of the filter 110. For example, the first opening 111 may be formed concavely from the boundary of the filter 110 toward the inside.

Therefore, forming of the first opening 111 may be easier than forming of a through-hole in the filter 110. Also, even when the filter 110 is attached to the screen 1 with some misalignment or the filter 110 is pushed while using the electronic display device, the filter 110 may not block the device such as the camera, etc.

The magnetic sheet 120 may be arranged on one surface of the filter 110.

The magnetic sheet 120 may include a magnetic material that may be attached to the magnet built in the electronic display device. Therefore, when the magnetic privacy screen filter 10 is arranged adjacent to the electronic display device, the magnetic sheet 120 may be attached to the magnet built in the electronic display device and the magnetic privacy screen filter 10 may be attached to the electronic display device.

In an embodiment, the magnetic sheet 120 may be arranged along at least part of the boundary of the filter 110.

In a specific embodiment, the magnetic sheet 120 may be arranged along a top portion on the surface of the filter 110.

The electronic display device generally has the magnet built in the upper end surface of the device, and thus, the magnetic sheet 120 may be arranged along the top of the filter 110 to be attached to the magnet.

However, the present disclosure is not limited thereto, and when the magnet is built in a position other than the upper end surface of the electronic display device, the magnetic sheet 120 may be arranged in another surface of the filter 110, which corresponds to the position of the magnet.

In an embodiment, the magnetic sheet 120 may be formed to extend along at least a part of the boundary of the filter 110 to have a length.

In a specific embodiment, the magnetic sheet 120 may be formed to extend to a length corresponding to a length of the top surface in the boundary of the filter 110.

In an embodiment, the magnetic sheet 120 may be only arranged on one surface of the filter 110. Specifically, the magnetic sheet 120 may be arranged on an outer side surface where the magnetic privacy screen filter 10 does not come into contact with the screen 1. For example, based on FIG. 6, when a right side is a surface contacting the screen 1 and a left side is a surface not contacting the screen 1, the magnetic sheet 120 may be arranged on the left side.

Because the magnetic sheet 120 is attached to the electronic display device due to mutual attractive force with the magnet built in the electronic display device, the magnetic sheet may be sufficiently attached and the adhesive force does not reduce even when the filter 110 is between the magnetic sheet 120 and the magnet.

Also, because the magnetic sheet 120 is arranged on the outer side surface of the filter 110, the magnetic sheet may prevent damage to the filter 110 due to external foreign matters or impact.

In an embodiment, the magnetic sheet 120 may include a second opening 121 formed in a position corresponding to the first opening 111 formed in the filter 110.

As described above, the filter 110 may include the first opening 111 that is concave toward the inside. Accordingly, the magnetic sheet 120 may include the second opening 121 formed in the position corresponding to the first opening 111 of the filter 110 so as not to block the device such as a camera, etc. while being attached to the filter 110. For example, the second opening 121 may be formed concave from the boundary of the magnetic sheet 120 toward the inside.

In an alternative embodiment, the magnetic sheet 120 may have the same shape as a part of the upper portion of the filter 110. For example, based on FIG. 5, the magnetic sheet 120 is formed to have the same shape as a part of the top portion of the filter 110, and thus, when the magnetic filter is attached to one surface of the filter 110, the magnetic sheet may completely overlap the top portion of the filter 110.

The magnetic privacy screen filter 10 may further include a double-sided adhesive tape 130.

The double-sided adhesive tape 130 may be provided to couple the filter 110 and the magnetic sheet 120 to each other.

In an embodiment, the double-sided adhesive tape 130 may be formed to have the same shape as that of the magnetic sheet 120. For example, the double-sided adhesive tape 130 is formed to be the same as the magnetic sheet 120, one surface of the double-sided adhesive tape 130 is attached to the magnetic sheet 120 and the other surface is attached to the filter 110, and thus, the magnetic sheet 120 may be coupled to the filter 110.

In a specific embodiment, the double-sided adhesive tape 130 may include a third opening 131 formed in a position corresponding to the second opening 121 formed in the magnetic sheet 120.

As described above, the filter 110 includes the first opening 111 and the magnetic sheet 120 includes the second opening 121 so as not to block the device such as the camera, etc., and thus, the double-sided adhesive tape 130 has the third opening 131 in the position corresponding to the first opening 111 of the filter 110 and the second opening 121 of the magnetic sheet 120 so as not to block the device such as the camera, etc.

An adhesive tape 140 may be arranged on one surface of the filter 110.

In an embodiment, the adhesive tape 140 may be arranged on one surface, between opposite surfaces of the filter 110, to which the magnetic sheet 120 is not attached.

The adhesive tape 140 may be arranged on one surface of the filter 110 to be adhered to the screen 1.

Therefore, when the user attaches the magnetic privacy screen filter 10 according to the present disclosure to the screen 1 and uses, separation of the magnetic privacy screen filter 10 from the screen 1 may be prevented.

For example, when the user turns over or tilts the electronic display device or folds a display of a laptop, etc., a part where the magnetic sheet 120 is not arranged may be separated from the screen 1. The adhesive tape 140 provides a certain adhesive force so as to prevent the magnetic privacy screen filter 10 from separating from the screen 1.

In an alternative embodiment, the adhesive tape 140 may be arranged on an opposite surface of the magnetic sheet 120, and at an opposite side. Referring back to FIG. 6, when the magnetic sheet 120 is arranged on the upper end at the left side based on FIG. 6, the adhesive tape 140 may be arranged on the lower end at the right side.

Accordingly, even when the electronic display device is turned over or tilted, a part of the magnetic privacy screen filter 10 may not be separated from the screen 1.

In an embodiment, the adhesive tape 140 may be formed to extend along at least a part of the boundary of the filter 110 to have a length.

Therefore, the adhesive tape 140 may be adhered to the screen 1 as much as the length of the adhesive tape 140, and thus, the magnetic privacy screen filter 10 may be sufficiently adhered to the screen 1.

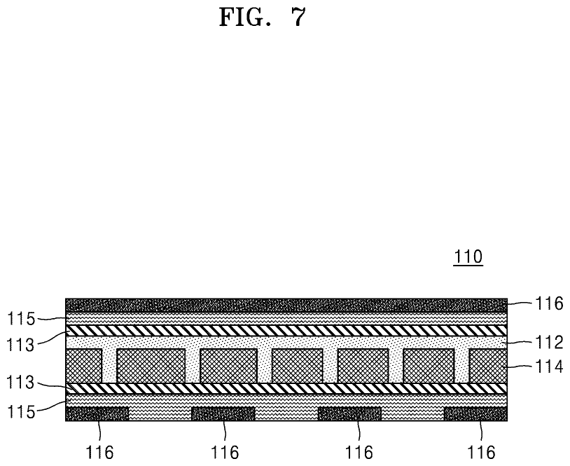

FIG. 7 is a diagram for describing a structure of the filter 110 of FIG. 3 according to an embodiment.

The filter 110 according to the embodiment may be used in the electronic display device such as a notebook computer, a laptop computer, etc.

Referring to FIG. 7, the filter 110 may include a core layer 112, protective layers 113, bonding layers 114, and a coating layer.

The core layer 112 may perform a function of selectively blocking the information on the screen 1 according to a viewing angle.

The core layer 112 may include a louver structure. The core layer 112 may perform a micro-louver function. For example, the core layer 112 may have a structure including a plurality of plates that are slanted and arranged horizontally with each other at certain intervals therebetween. Therefore, light displayed from the screen 1 may only reach the user watching the screen 1 from the outside within a certain viewing angle range by passing through the core layer 112.

The protective layers 113 may be arranged on at least one surface of the core layer 112 to protect the core layer 112.

In an embodiment, the protective layers 113 may be arranged on opposite surfaces of the core layer 112 to prevent damage to the core layer 112 and prevent the core layer 112 from losing its function.

The protective layer 113 may be a polyethylene terephthalate (PET) film. For example, the protective layer 113 may include an optical PET film. However, the present disclosure is not limited to the above example.

The bonding layer 114 may couple the protective layers 113 to the core layer 112.

The bonding layer 114 may include an optical clear adhesive (OCA), but is not limited thereto.

In an embodiment, the bonding layer 114 may be formed on a surface, between opposite surfaces of the core layer 112, on which the louver structure is formed, and may be arranged between the louvers. Therefore, the coupling between the core layer 112 and the protective layer 113 may become firm.

The coating layer arranged on an outer surface of the filter 110. The coating layer may perform various functions for protecting the filter 110.

In an embodiment, the coating layer may include first coating layers 115. The first coating layers 115 may be hard coating layers. For example, the first coating layers 115 may be anti-scratch coating layers.

In an alternative embodiment, the first coating layers 115 may be arranged on opposite surfaces of the filter 110, and in detail, on outer surfaces of the protective layers 113.

Therefore, even when dust or foreign matters are between the magnetic privacy screen filter 10 and the screen 1, scratches generating on the filter 110 may be prevented. Also, when the user touches the outer surface of the magnetic privacy screen filter 10 or external impact is applied, the magnetic privacy screen filter 10 may be protected.

In an embodiment, the coating layer may include second coating layers 116. The second coating layers 116 may be anti-fingerprint coating layers.

Therefore, even when the user directly touches the magnetic privacy screen filter 10 with the hands, the fingerprint may be prevented from remaining on the surface of the filter 110 and blocking the view.

In an alternative embodiment, in one surface of the filter 110, the surface attached to the screen 1 may have the first coating layer 115 and the second coating layer 116 mixed with each other. For example, based on FIG. 7, the lower end portion of the filter 110 may be attached to the screen 1, and the lower end surface may have the first coating layer 115 and the second coating layer 116 mixed with each other. Therefore, during the process of attaching the magnetic privacy screen filter 10 to the screen 1, the fingerprint may be prevented from remaining on the inner surface.

On the contrary, in the case of the electronic display device such as a notebook computer, a laptop computer, etc., the user rarely touches the screen 1, and thus, the coating layer arranged on one surface of the filter 110, which does not come into contact with the screen 1, may not include the first coating layer 115 and the second coating layer 116 mixed with each other.

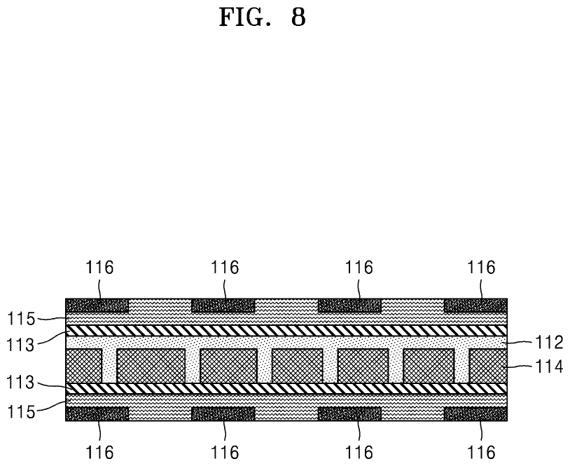

FIG. 8 is a diagram for describing a structure of the filter 110 of FIG. 3 according to another embodiment.

Hereinafter, for convenience of description, differences from the filter 110 of the embodiment described above with reference to FIG. 7 are described below.

The filter 110 according to the present embodiment may be used in an electronic display device such as a smartphone and a tablet PC.

Referring to FIG. 8, the filter 110 may include the core layer 112, the protective layers 113, the bonding layers 114, and a coating layer.

The core layer 112 may include a louver structure to perform a micro-louver function. Therefore, the core layer 112 may transmit the light displayed from the screen 1 only to the user who watches the screen 1 within a certain viewing angle range.

The protective layers 113 may be arranged on at least one surface of the core layer 112 to protect the core layer 112, and in an embodiment, the protective layers 113 may be arranged on opposite surfaces of the core layer 112.

The bonding layers 114 are layers for coupling the protective layers 113 to the core layer 112 and may include an OCA, but are not limited thereto.

The coating layer is arranged on the outer surface of the filter 110 and may perform various functions for protecting the filter 110.

In an embodiment, the coating layer may include the first coating layers 115 preventing scratches and the second coating layers 116 preventing the fingerprint smudge.

In an alternative embodiment, the filter 110 according to the present embodiment may have coating layers on opposite surfaces thereof, the coating layers may include mixture of the first coating layers 115 and the second coating layers 116.

For example, based on FIG. 8, the lower end portion of the filter 110 is attached to the screen 1, and the upper end portion is a part facing the eyes of the user.

In this case, the coating layer arranged on the lower end surface may include the first coating layer 115 and the second coating layer 116 mixed with each other so as to prevent the scratches from generating on the filter 110 even when dust or foreign matters are between the magnetic privacy screen filter 10 and the screen 1, and at the same time, also prevent the fingerprint smudge from remaining on the inner surface during the process of attaching the magnetic privacy screen filter 10 to the screen 1.

Also, the coating layer arranged on the upper end surface includes the first coating layer 115 and the second coating layer 116 mixed with each other, so as to prevent or reduce the scratches or fingerprint smudge that may be generated when the user touches the screen 1 of the electronic display device.

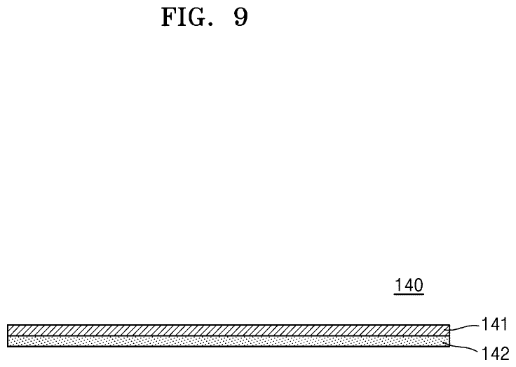

FIG. 9 is a diagram for describing a structure of the adhesive tape 140 of FIG. 4.

Referring to FIG. 9, the adhesive tape 140 may have a multi-layered structure.

In an embodiment, the adhesive tape 140 may include an attaching portion 141 and an adhesive portion 142.

The attaching portion 141 may be a part attached to the filter 110.

In an embodiment, the attaching portion 141 may include PET, but is not limited thereto.

The attaching portion 141 may be formed along a lengthwise direction of the adhesive tape 140. Therefore, the attaching portion 141 may allow the adhesive tape 140 to be firmly coupled to one surface of the filter 110.

The adhesive portion 142 may be a part adhered to the screen 1.

In an embodiment, the adhesive portion 142 may include a silicone adhesive.

Therefore, the adhesive portion 142 may provide an adhesive force that is enough to attach the magnetic privacy screen filter 10 to the screen 1 against gravity, rather than the adhesive force allowing the screen filter 10 to be completely attached and coupled to the screen 1.

Therefore, when the user attaches the magnetic privacy screen filter 10 according to the present disclosure to the screen 1 and uses, isolation of the magnetic privacy screen filter 10 from the screen 1 may be prevented.

The adhesive portion 142 may be formed along a lengthwise direction of the adhesive tape 140. Therefore, the adhesive portion 142 may allow the adhesive tape 140 to be stably adhered to the screen 1 and not to be easily separated from the screen 1.

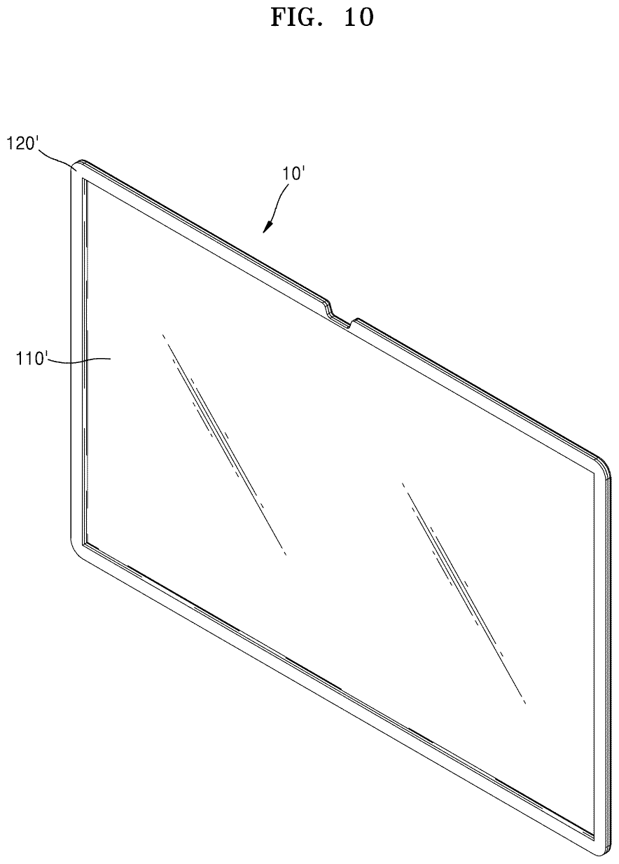

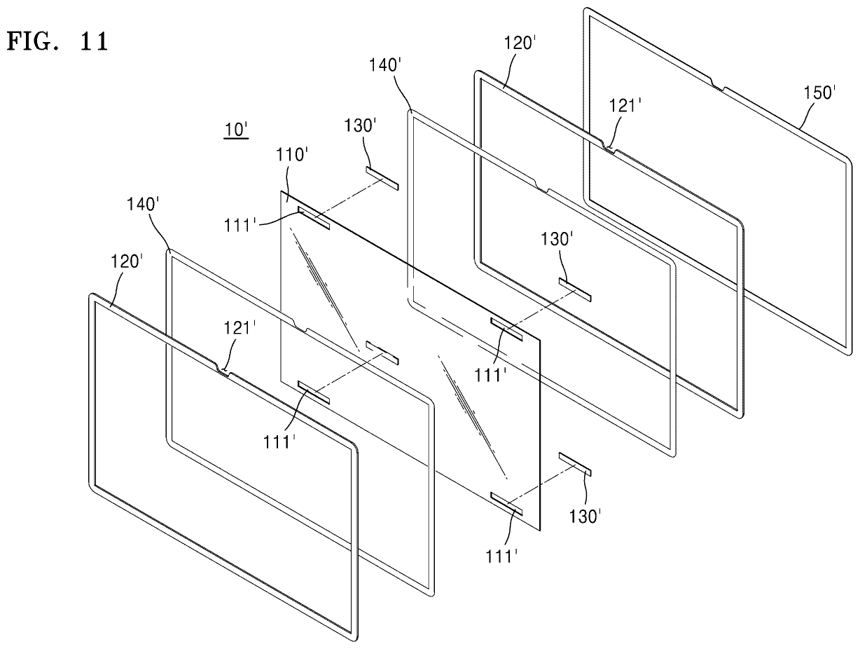

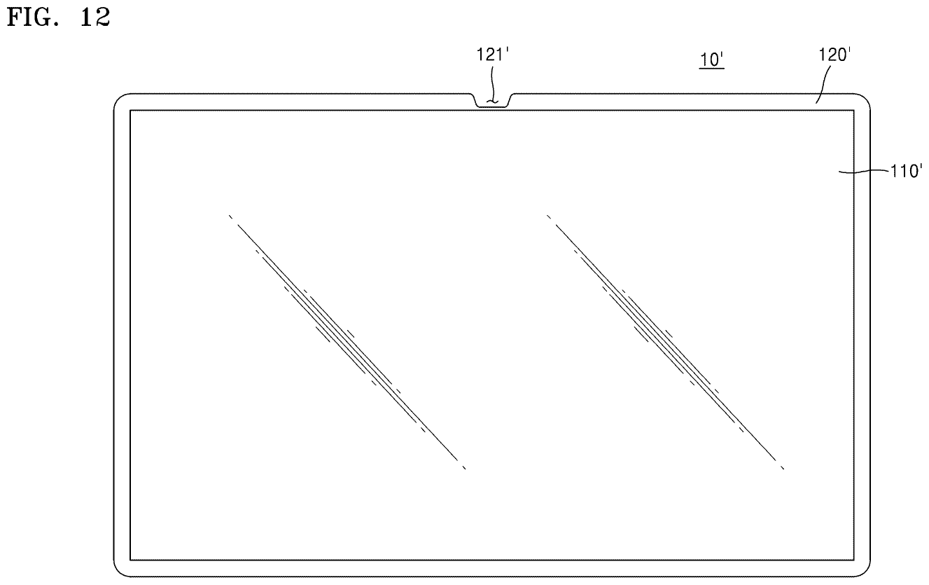

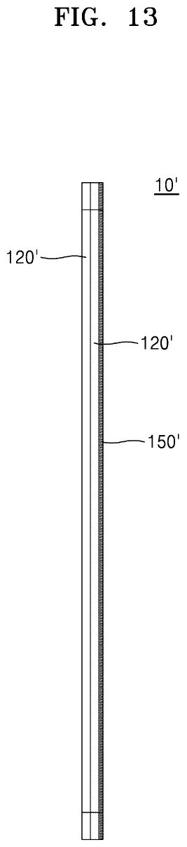

FIG. 10 is a perspective view schematically showing a magnetic privacy screen filter 10′ according to an embodiment of the present disclosure, and FIG. 11 is an exploded perspective view of the magnetic privacy screen filter 10′ of FIG. 10. FIG. 12 is a diagram schematically showing the magnetic privacy screen filter 10′ of FIG. 10, which is seen from the front, and FIG. 13 is a diagram schematically showing the magnetic privacy screen filter 10′ of FIG. 10, which is seen from the side.

For convenience of description, matters that are the same as or may be easily modified from the above embodiment described with reference to FIGS. 3 to 9 are briefly described or omitted hereinafter.

Referring to FIGS. 10 to 13, the magnetic privacy screen filter 10′ according to another embodiment of the present disclosure may include a filter 110′, a fixing tape 120′, an insertion member 130′, and an adhesive layer 150′.

The filter 110′ may be arranged on one surface of an electronic display device and cover the screen 1.

The filter 110′ may block the information displayed on the screen 1 selectively according to a viewing angle.

In an embodiment, the filter 110′ may include at least one through-hole 111′, and the magnetic privacy screen filter 10′ may include the insertion member 130′ that is inserted into the through-hole 111′ formed in the filter 110′.

Internal structure and functions of the filter 110′ may be the same as those of the filter 110 described above with reference to FIGS. 7 and 8.

The insertion member 130′ may include a material having a property of attaching to the magnet built in the electronic display device. [symbol] Therefore, when the magnetic privacy screen filter 10′ is arranged adjacent to the electronic display device, the insertion member 130′ may be attached to the magnet built in the electronic display device and the magnetic privacy screen filter 10′ may be attached to the electronic display device.

In an embodiment, the insertion member 130′ may be a steel plate.

In an embodiment, there may be a plurality of insertion members 130′. Also, the filter 110′ may include a plurality of through-holes 111′ to correspond to the insertion members.

In a specific embodiment, the plurality of through-holes 111′ may be formed along the boundary of the filter 110′, and the plurality of insertion members 130′ may be inserted along the boundary of the filter 110′.

Here, one of ordinary skill in the art would appreciate that the through-holes 111′ and the insertion members 130′ may be provided to correspond to the locations and the number of magnets built-in the electronic display device.

Therefore, the magnetic privacy screen filter 10′ may be firmly attached to the screen 1.

The magnetic privacy screen filter 10′ may include the fixing tapes 120′ arranged on opposite surfaces of the filter 110′.

In an embodiment, the fixing tapes 120′ may be arranged along the boundary of the filter 110′. The fixing tapes 120′ are arranged along the boundary of the filter 110′, and may each have a width that may completely close the through-holes 111′ formed in the filter 110′.

Therefore, after the insertion members 130′ are inserted into the through-holes 111′, the fixing tapes 120′ may be arranged on the opposite surfaces of the filter 110′ to close the through-holes 111′ and fix the insertion members 130′ at right positions.

In an alternative embodiment, the fixing tape 120′ may include a Poron tape. The Poron tape may be a tape formed of polyurethane (PU) material.

Therefore, when the fixing tapes 120′ are arranged to surround the boundary of the filter 110′, the electronic display device, as well as the magnetic privacy screen filter 10′, may be protected against external impact due to a cushioning property of the Poron tape and high compressive rate.

In an embodiment, the fixing tape 120′ may include a fourth opening 121′.

The electronic display device may frequently have various devices such as a camera, a sensor, etc. in an upper portion of the screen 1. Therefore, when the magnetic privacy screen filter 10′ is arranged to encompass the boundary of the screen 1, there is a concern that the magnetic privacy screen filter may block the device such as a camera, etc. to hinder the functions.

Therefore, the fixing tape 120′ may include the fourth opening 121′ formed at a position corresponding to the camera, etc. so as not to block the device such as the camera, etc.

In an alternative embodiment, the fourth opening 121′ may be formed concave toward the inside of the fixing tape 120′. For example, the fourth opening 121′ may be formed concave from the outer boundary of the fixing tape 120′ toward the inside. Therefore, forming of the fourth opening 121′ in the fixing tape 120′ may be easier than the forming of the through-hole 111′.

The magnetic privacy screen filter 10 may further include a double-sided adhesive tape 140′.

The double-sided adhesive tape 140′ may be provided to couple the filter 110′ and the fixing tape 120′ to each other.

In an embodiment, the double-sided adhesive tape 140′ may be formed to have the same shape as that of the fixing tape 120′. For example, the double-sided adhesive tape 140′ may be formed to be the same as the fixing tape 120′, and one surface of the double-sided adhesive tape 140′ is attached to the fixing tape 120′ and the other surface is attached to the filter 110′. Thus, the fixing tape 120′ may be coupled to the filter 110′. Here, the entire boundary of the fixing tape 120′ may be greater than the boundary of the filter 110′, and thus, parts of the double-sided adhesive tape 140′ attached to the fixing tape 120′ may be attached to each other so that the fixing tapes 120′ are coupled to each other.

The magnetic privacy screen filter 10′ may further include an adhesive layer 150′.

The adhesive layer 150′ may be arranged on one surface of the fixing tape 120′.

The adhesive layer 150′ may be arranged on one surface of the fixing tape 120′ and adhered to the screen 1.

Therefore, when the user attaches the magnetic privacy screen filter 10′ according to the present disclosure to the screen 1 and uses, separation of the magnetic privacy screen filter 10′ from the screen 1 may be prevented.

For example, the adhesive layer 150′ provides a certain adhesive force so as to prevent the magnetic privacy screen filter 10′ from separating from the screen 1.

In an embodiment, the adhesive layer 150′ may be arranged on one surface of the fixing tape 120′ so as to correspond to the shape of the fixing tape 120′. For example, the adhesive layer 150′ may be arranged to cover one entire surface of the fixing tape 120′ so as to be arranged along the boundary of the filter 110′, like the fixing tape 120′.

Therefore, the adhesive layer 150′ may come into contact with the screen 1 through a large area, and thus, may provide a sufficient adhesive force so that the magnetic privacy screen filter 10′ may be sufficiently adhered to the screen 1.

In an embodiment, the adhesive layer 150′ may include a silicone adhesive. For example, the adhesive layer 150′ may be formed by applying the silicone adhesive onto one surface of the fixing tape 120′. In another example, the adhesive layer 150′ may be formed by attaching an additional member including the silicone adhesive onto one surface of the fixing tape 120′.

In another embodiment, the adhesive layer 150′ may be a part of the fixing tape 120′. For example, the adhesive layer 150′ may include a Poron tape, and in particular, the Poron tape is processed to have the adhesive force.

Therefore, the adhesive layer 150′ may provide an adhesive force that is enough to attach the magnetic privacy screen filter 10′ to the screen 1 against the gravity, rather than the adhesive force allowing the screen filter 10′ to be completely attached and coupled to the screen 1.

While the disclosure has been particularly shown and described with reference to exemplary embodiments thereof, it will be understood by those of ordinary skill in the art that various changes in form and details may be made therein without departing from the spirit and scope as defined by the following claims. Therefore, the scope sought to be protected of the disclosure shall be defined by the appended claims.

The particular implementations shown and described herein are illustrative examples of the embodiments and are not intended to otherwise limit the scope of the embodiments in any way. For the brevity of the specification, the description of conventional electronic configurations, control systems, software, and other functional aspects of the systems may be omitted. Connections of lines or connection members between components shown in the drawings are illustrative of functional connections and/or physical or circuit connections, and in practice, may be represented as alternative or additional various functional connections, physical connections, or circuit connections. Moreover, no item or component is essential to the practice of the disclosure unless the element is specifically described as “essential” or “critical”.

The singular forms “a,” “an” and “the” in the specification of the embodiments, in particular, claims, may be intended to include the plural forms as well. Unless otherwise defined, the ranges defined herein is intended to include values within the range as individually applied and may be considered to be the same as individual values constituting the range in the detailed description. Finally, operations constituting methods may be performed in appropriate order unless explicitly described in terms of order or described to the contrary. Exemplary embodiments are not necessarily limited to the order of operations given in the description. The examples or exemplary terms (for example, etc.) used herein are to merely describe exemplary embodiments in detail are not intended to limit the embodiments unless defined by the following claims. Also, those of ordinary skill in the art will readily appreciate that many alternations, combinations and modifications, may be made according to design conditions and factors within the scope of the appended claims and their equivalents.

### INDUSTRIAL APPLICABILITY

The magnetic privacy screen filter according to the embodiments of the present disclosure may be applied to industrial magnetic privacy screen filters.

1. A magnetic privacy screen filter comprising:
a filter blocking information displayed on a screen selectively according to a viewing angle;
a magnetic sheet arranged only on one surface of the filter; and
an adhesive tape arranged on another surface of the filter,
wherein:
the adhesive tape has a multi-layered structure comprising an attaching portion attached to the filter; and an adhesive portion arranged on one face of the attaching portion, having a lower adhesive force than that of the attaching portion, and adhering to the screen to prevent detachment of the filter from the screen during use,
the filter comprises a core layer formed with a plurality of plates extending in one direction from a single plate, the plurality of plates being arranged to be spaced apart from each other; a bonding layer arranged in spaces between the plurality of plates of the core layer; a protective layer arranged on both surfaces of the core layer; and a coating layer arranged on an outer surface of the protective layer,
the coating layer comprises a first coating layer configured to prevent scratches caused by external impacts; and a second coating layer configured to prevent user's fingerprints from remaining,
a coating layer on an upper side of the core layer comprises a first coating layer and a second coating layer disposed side by side to form a layered structure,
a coating layer on a lower side of the core layer is formed from a mixture of a first coating layer and a second coating layer,
the magnetic sheet is arranged along only one side of a boundary of the filter, and
the adhesive tape is arranged along a side of the boundary opposite to the magnetic sheet.

2. The magnetic privacy screen filter of claim 1, wherein the magnetic sheet is formed to extend to have a length along at least a part of a boundary of the filter.

3. The magnetic privacy screen filter of claim 2, wherein
the filter comprises a first opening formed concave toward inside, and
the magnetic sheet comprises a second opening formed in a position corresponding to the first opening formed in the filter.

4. The magnetic privacy screen filter of claim 1, wherein the adhesive tape is formed to extend to have a length along at least a part of a boundary of the filter.
